(19) United States
(12) Patent Application Publication
(10) Pub. No.: US 2004/0265596 A1
(43) Pub. Date: Dec. 30, 2004

(54) Epoxy resin composition for semiconductor sealing and semiconductor device

(75) Inventor: Masakatsu Maeda, Utsunomiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SUMITOMO BAKELITE CO., LTD., Tokyo (JP)

(21) Appl. No.: 10/821,852

(22) Filed: Apr. 12, 2004

(30) Foreign Application Priority Data
Apr. 28, 2003 (JP) 2003-123879

(51) Int. Cl. B32B 27/38; C08L 63/00

(52) U.S. Cl. 428/413; 523/400; 523/440

(57) ABSTRACT

Outstanding YAG laser marking characteristics can be obtained without electric defects such as a short circuit and leak current and without deforming gold wires by using an epoxy resin composition for semiconductor sealing comprising an epoxy resin, a phenol resin, an inorganic filler, a curing accelerator, and a carbon precursor having a specific electric resistivity in a semiconductor region of 1×10²·cm or more but less than 1×10⁷·cm as essential components, wherein the amounts of the inorganic filler and the carbon precursor in the epoxy resin composition are respectively 65-92 wt % and 0.1-5.0 wt %.

### BACKGROUND OF THE INVENTION

1. Field of the Invention

The present invention relates to an epoxy resin composition for semiconductor sealing excelling in laser marking properties and electrical properties, and to a semiconductor device using the epoxy resin composition.

2. Description of Background Art

Conventionally, semiconductor devices sealed mainly with an epoxy resin composition contain carbon black having conductivity used as a coloring agent in the composition. If an epoxy resin composition containing carbon black as a coloring agent is used, semiconductor devices not only have excellent properties for covering semiconductor elements, but also can produce clear white printing images on the black background when product numbers, lot numbers, and the like are marked on the semiconductor elements in a white color. In particular, since many electronic part manufacturers adopt YAG laser marking that can be handled with ease in recent years, carbon black which can absorb laser beams at the YAG laser wavelength is an essential component in an epoxy resin composition for semiconductor sealing.

As an epoxy resin composition suitable for YAG laser marking, a thermoset resin composition containing 0.1-3 wt % of carbon black having a carbon content of 99.5% or more and a hydrogen content of 0.3 wt % or less is known (Japanese Patent Application Laid-open No. 1990-127449).

However, due to the fine pitch wiring in semiconductor devices in recent years, use of carbon black or the like containing large aggregates as a conductive coloring agent or the like induces electrical failures such as a circuit shortage and occurrence of a leak current, when such large aggregates of carbon black are present between inner leads or between wires. Moreover, if large aggregates of carbon black or the like are stuck in narrowed spaces between wires, the wires receive a stress which also causes failures of electrical properties.

As a means for solving these problems, Japanese Patent Application Laid-open No. 2001-335677 discloses an epoxy resin composition for sealing containing non-conductive carbon with an electric resistance of 10⁷ or more as a substitute for carbon black. Electronic part devices equipped with an element sealed with this epoxy resin composition for sealing have good YAG laser marking properties without producing a leak current. The epoxy resin composition exhibits excellent formability and produces packages with a beautiful external appearance.

However, although the electronic part devices equipped with an element sealed with the epoxy resin composition for sealing containing non-conductive carbon with an electric resistance of 10⁷ or more can prevent a short circuit of wiring and a leak current, these electronic part devices do not have sufficient electronic characteristics. The epoxy resin composition produces reaggregates with a particle size of about 80 μm or more by static electricity due to the high insulation. The reaggregates are stuck in narrow spaces between wires, giving rise to gold wire dislocation. There has been no epoxy resin composition having such a high electric specific resistivity and producing no reaggregates by static electricity reported in the past and development of such an epoxy resin composition is strongly desired.

Therefore, an objective of the present invention is to provide an epoxy resin composition for semiconductor sealing exhibiting outstanding YAG laser marking properties and being free from a short circuit, a leak current, and gold wire dislocation, and to provide a semiconductor device using this epoxy resin composition.

### SUMMARY OF THE INVENTION

In view of the above-described situation, the inventor of the present invention has conducted extensive studies and, as a result, has found that an epoxy resin composition comprising a carbon precursor having a specific electric resistivity in a semiconductor region of 1×10²·cm or more but less than 1×10⁷·cm as a coloring agent can exhibit outstanding YAG laser marking properties and is free from a short circuit, a leak current, and gold wire dislocation. This finding has led to the completion of the present invention.

Specifically, the present invention provides an epoxy resin composition for semiconductor sealing comprising an epoxy resin, a phenol resin, an inorganic filler, a curing accelerator, and a carbon precursor having a specific electric resistivity in a semiconductor region of 1×10²·cm or more but less than 1×10⁷·cm as essential components, wherein the amounts of the inorganic filler and the carbon precursor in the epoxy resin composition are respectively 65-92 wt % and 0.1-5.0 wt %.

The present invention also provides a semiconductor device comprising a semiconductor element sealed using the epoxy resin composition for semiconductor sealing.

Semiconductor devices sealed with the epoxy resin composition of the present invention can produce clear white printing images and a clear contrast in the area marked with YAG laser beams on the black background. Moreover, since excellent printing by YAG laser beams can be achieved at a high speed and low voltage, the manufacturing efficiency can be improved. In addition, since it is unnecessary to use conductive particles such as carbon black as a coloring agent, occurrence of a short circuit and leak current due to conductive particles stuck in the spaces between finely pitched wires in semiconductor devices can be avoided. Furthermore, due to the use of carbon precursor having a specific electric resistivity in a semiconductor region, reaggregation of carbon particles by static electricity can be prevented and the risk of dislocation of gold wires by the reaggregates stuck in the spaces between the gold wires can be avoided.

### DETAILED DESCRIPTION OF THE INVENTION

The epoxy resin composition for semiconductor sealing of the present invention contains an epoxy resin, a phenol resin, an inorganic filler, a curing accelerator, and a carbon precursor as essential components. There are no specific limitations to the type of epoxy resin used in the present invention inasmuch as the resin has two or more epoxy groups in the molecule. Examples include an o-cresolnovolac epoxy resin, phenolnovolac epoxy resin, triphenolmethane epoxy resin, bisphenol epoxy resin, biphenyl epoxy resin, stylbenzene epoxy resin, dicyclopentadiene-modified phenol epoxy resin, and naphtol epoxy resin. These epoxy resins can be used either individually or in combination of two or more. Epoxy resins having an epoxy equivalent of 150-300 are preferable in view of curability of the epoxy resin composition.

There are no specific limitations to the phenol resin used in the present invention insofar as the resin has a phenolic hydroxyl group in the molecule. Examples include a phenolnovolac resin, phenolaralkyl resin, triphenolmethane resin, and terpene-modified phenol resin. These phenol resins can be used either individually or in combination of two or more. Phenol resins having a hydroxyl group equivalent of 80-250 are preferable in view of curability of the epoxy resin composition.

Any fillers commonly used as a sealing material can be used as the inorganic filler in the present invention. Examples include fused and frake silica, fused spherical silica, crystal silica, alumina, titanium white, aluminum hydroxide, talc, clay, and glass fiber. Although there are no specific limitations to the particle size distribution of the inorganic fillers, inorganic fillers having a particle size of 150 μm or less, and preferably 0.1-75 μm, are preferable due to ease of being filled in narrow spaces of a die when the resin composition is molded.

The amount of inorganic fillers to be added is 65-92 wt %, and preferably 70-91 wt %, of the total amount of the epoxy resin composition. If the amount is less than the lower limit, the resin composition is easily discolored by heating during YAG laser marking due to an increased relative amount of the resin components. Additives such as a heat discoloration preventive for resin components must be separately added to obtain a clear contrast. Too small an amount of the inorganic fillers increases moisture absorption of the cured products of the epoxy resin composition, which impairs characteristics such as solder crack resistance and moisture resistance. If the amount exceeds the upper limit, flowability of the resin composition decreases.

As the curing accelerator, any curing accelerators commonly used as sealing materials that can accelerate the reaction of an epoxy group with a phenolic hydroxyl group can be used in the present invention without a specific limitation. As examples of such a curing accelerator, 1,8-diazabicyclo(5,4,0)undecene-7, triphenylphosphine, benzyldimethylamine, and 2-methylimidazole can be given. These curing accelerators can be used either individually or in combination of two or more.

The carbon precursor used in the present invention has a specific electric resistivity in a semiconductor region of 1×10²·cm or more but less than 1×10⁷·cm, and preferably of 1×10⁴·cm or more but less than 1×10⁷·cm. The carbon precursor has an H/C ratio by weight of 2/97 to 4/93, and preferably 2/97 to 4/94, more preferably 2/97 to 4/95. A carbon precursor having a specific electric resistivity of less than 1×10²·cm or an H/C ratio by weight of less than 2/97 is not preferable, because such a carbon precursor has a high conductivity and causes a leak current. On the other hand, a carbon precursor with a specific electric resistivity of more than 1×10⁷·cm or an H/C ratio by weight of more than 4/93 is undesirable since such a carbon precursor has characteristics closer to an insulated region, by which the carbon precursor particles tend to reaggregate and may cause dislocation of gold wires during sealing. The H/C ratio by weight of 2/97 to 4/93 indicates that the carbon content and hydrogen content of the carbon precursor determined by elemental analysis are respectively 97-93 wt % and 2-4 wt %, preferably 97-94 wt % and 2-4 wt %. The carbon precursor is fine particles with an average particle diameter of 0.5-50 μm, and preferably 0.5-20 μm. If the average particle diameter of the carbon precursor is less than 0.5 μm, YAG laser marking properties decrease; if more than 50 μm, tinting strength is reduced, resulting in an impaired external appearance of the products. If there are aggregates with a size larger than about 80 μm in the formed products to be sealed, gold wires are easily deformed. However, if the resin composition for sealing containing the carbon precursor of the present invention is used, such aggregates will not be produced and no stress is applied to the gold wires. The resin composition of the present invention can thus exhibit excellent electrical characteristics.

The specific electric resistivity can be determined using a conventionally known method, specifically, according to the method conforming to JIS Z3197. According to the method, after applying a flux to a G-10 or SE-4 substrate of an epoxy resin copper clad laminate on a glass fabric substrate having a comb pattern, the pattern is soldered, and the resistivity is measured at DC 100 V using an ohm meter at 25° C. and 60% RH.

There are no specific limitations to the method for producing the carbon precursor of the present invention. One example of such a method comprises carbonizing an aromatic polymer such as a resole resin, phenol resin, or polyacrylonitrile at a firing temperature of 600-650° C. for an appropriate period of time. Either one type of carbon precursor or a mixture of two or more types of carbon precursors produced in this manner can be used.

The amount of carbon precursors to be added is 0.1-5.0 wt %, and preferably 0.3-5.0 wt %, of the total amount of the epoxy resin composition. If the amount of carbon precursors added is less than 0.1 wt %, the black color of the cured product turns into light gray, making it difficult to obtain a clear contrast between printed white characters and the black background. If the amount exceeds 5.0 wt %, the flowability of the epoxy resin for semiconductor sealing decreases.

In addition to the above-described essential components, various additives such as a coupling agent, flame retardant, releasing agent, low stress agent, and antioxidant may be optionally added to the epoxy resin for semiconductor sealing of the present invention.

The epoxy resin composition for semiconductor sealing of the present invention can be produced by homogeneously mixing the above-mentioned essential components and other additives using a mixer or the like at an ordinary temperature, melting and kneading the mixture using a kneading machine such as a heating roller, a kneader, or an extruder, cooling the kneaded material, and pulverizing the resulting product.

The semiconductor device of the present invention can be produced by sealing electronic parts such as semiconductor elements using the above-described epoxy resin composition for semiconductor sealing. As a method for sealing the electronic parts using the epoxy resin composition for semiconductor sealing of the present invention, molding methods such as transfer mold, compression mold, and injection mold can be given, for example.

### EXAMPLES

The present invention will be described in more detail by examples, which should not be construed as limiting the present invention.

### Example 1

The components listed in Table 1 were mixed at an ordinary temperature using a mixer. The mixture was melted and kneaded using a heating roller at 80-100° C. and the kneaded product was cooled and pulverized to obtain an epoxy resin composition. Resulting epoxy resin composition was evaluated according to the following method of evaluation. The results are shown in Table 2.

TABLE 1

| | |
|---|---|
| Biphenyl epoxy resin; YX4000H, melting point: 105° C., | 8.5 parts |
| epoxy equivalent: 195 g/eq, manufactured | by weight |
| by Yuka Shell Epoxy Co., Ltd | |
| Phenolnovolac resin; softening point: 65° C., | 4.5 parts |
| hydroxyl group equivalent: 104 g/eq | by weight |
| Fused spherical silica; average particle diameter: | 84.4 parts |
| 22 μm, maximum particle diameter: 75 μm | by weight |
| Carbon precursor A; CB-3-600, H/C ratio by weight = | 1.0 part |
| 3/96, average particle diameter: 3 μm, maximum | by weight |
| particle diameter: 20 μm, specific electric resistivity: | |
| 1 × 10⁶·cm, manufactured by Mitsui Mining | |
| Co., Ltd. | |
| Triphenylphosphine | 0.2 part |
| | by weight |
| Antimony trioxide | 1.0 part |
| | by weight |
| Carnauba wax | 0.4 part |
| | by weight |

<Evaluation Methods>

(Spiral flow)

Using a die conforming to EMMI-1-66, a flow distance (cm) was measured under the conditions of a die temperature of 175° C., injection pressure of 6.9 MPa, and curing time of 120 seconds. The product was rejected if the spiral flow distance was less than 100 cm, and accepted if the distance was 100 cm or more. (YAG laser marking properties)

Some pieces of 80pQFP (thickness: 2.7 mm) were formed using a low pressure transfer molding machine under the conditions of a die temperature of 175° C., injection pressure of 6.9 MPa, and curing time of 120 seconds, followed by post-curing at 175° C. for 8 hours. Characters were printed by marking at a voltage of 2.4 kV and a pulse width of 120 μs using a mask type YAG laser seal machine (manufactured by NEC Corp.) to evaluate visibility of printing (YAG laser marking property). Products exhibiting clear printing were deemed to be acceptable.

(External Appearance Observation)

12 packages of 80pQFP (14×20×2.0 mm thickness) were prepared by forming the resin compositions using a low pressure transfer molding machine under the conditions of a die temperature of 175° C., injection pressure of 6.9 MPa, and curing time of 70 seconds. External appearance (color of the cured product) was visually observed. A package with a black appearance was accepted and a gray one was rejected.

(Solder Crack Resistance)

22 packages of 80pQFP (thickness: 2.7 mm) were formed using a low pressure transfer molding machine under the conditions of a die temperature of 175° C., injection pressure of 6.9 MPa, and curing time of 120 seconds, followed by post-curing at 175° C. for 8 hours. The products were dried at 150° C. for 20 hours and humidified in a thermo-hygrostat (85° C., 60% RH) for 168 hours, followed by IR reflow processing at a peak temperature of 235° C. under JEDEC conditions. The presence or absence of external cracks was observed using an optical microscope. The results were indicated by n (the number of rejected products)/22. The moisture absorption rate (wt %) was calculated from the weight change before and after moisture absorption.

(High Temperature Leak Proof Characteristics)

100 pieces of 144pTQFP with gold wires, each having a diameter of 30 μm, bonded to a test chip at intervals of 60 μm were formed and sealed using a low pressure transfer molding machine under the conditions of a die temperature of 175° C., injection pressure of 7.8 MPa, and curing time of 90 seconds. The leak current was measured using a microammeter 8240A manufactured by ADVANTEST Co., Ltd. The products were rejected when the leak current increased by an order of 10² or more than the median value at 175° C. The results were indicated by n (the number of rejected products)/100.

(Evaluation of Aggregates)

A disk with a diameter of 100 mm was formed using a low pressure transfer molding machine under the conditions of a die temperature of 175° C., injection pressure of 6.9 MPa, and curing time of 120 seconds. The surface was ground and observed using a fluorescence microscope (BX51M-53MF, manufactured by Olympus Corp.) to count the number of aggregates with a size larger than 80 μm.

(Evaluation of Gold Wire Dislocation)

A package of 144pTQFP with gold wires, each having a length of 3 mm and a diameter of 25 μm, bonded to a test chip at intervals of 60 μm were formed and sealed using a low pressure transfer molding machine under the conditions of a die temperature of 175° C., injection pressure of 7.8 MPa, and curing time of 90 seconds. Dislocation of gold wires was measured using a soft X-ray apparatus PRO-TEST-100 (manufactured by Softex Co., Ltd.) which allows nondestructive inspection of gold wires in the package. The maximum gold wire dislocation rate was determined by the formula a/b×100 (%), wherein a is the maximum dislocation in the direction vertical to the length of gold wires and b is the length of gold wires. The test package with the maximum gold wire dislocation rate of 3% or more was judged to be rejected.

### Examples 2-4

The same experiment as in Example 1 was carried out except that the amount of carbon precursor A (1.0 part by weight in Example 1) was 1.8 parts by weight in Example 2, 3.0 parts by weight in Example 3, and 0.5 part by weight in Example 4. The amount of fused spherical silica was adjusted according to the amount of the carbon precursor A.

### Example 5

The experiment was carried out in the same way as in Example 1 except for using carbon precursor B instead of the carbon precursor A. The results are shown in Table 2.

Carbon precursor B: Spherical phenol resin with an average particle diameter of 15 μm was dried and carbonized at 650° C. for 4 hours to obtain carbon precursor B in an yield of 99%. The carbon precursor B obtained had a hydrogen/carbon ratio by weight of 2/97, an average particle diameter of 10 μm, the maximum particle diameter of 30 μm, and a specific electric resistivity of 1×10⁴·cm.

### Example 6

The experiment was carried out in the same manner as in Example 1 except for using 3.0 parts by weight of carbon precursor C instead of 1.0 part by weight of the carbon precursor A. The amount of fused spherical silica was adjusted according to the amount of the carbon precursor A. The results are shown in Table 2.

Carbon precursor C: Spherical phenol resin with an average particle diameter of 65 μm was dried and carbonized at 600° C. for 4 hours to obtain carbon precursor C in an yield of 99%. The carbon precursor C obtained had a hydrogen/carbon ratio by weight of 3/96, an average particle diameter of 45 μm, the maximum particle diameter of 60 μm, and a specific electric resistivity of 1×10⁶·cm.

### Example 7

The experiment was carried out in the same way as in Example 1 except for using carbon precursor D instead of the carbon precursor A. The results are shown in Table 2.

Carbon precursor D: Spherical phenol resin with an average particle diameter of 1.5 μm was dried and carbonized at 600° C. for 4 hours to obtain carbon precursor D in an yield of 99%. The carbon precursor D obtained had a hydrogen/carbon ratio by weight of 3/96, an average particle diameter of 1 μm, the maximum particle diameter of 10 μm, and a specific electric resistivity of 1×10⁶·cm.

### Comparative Example 1

The same experiment as in Example 1 was carried out except that the amounts of components were changed as shown in Table 2. Specifically, the amount of fused spherical silica in the epoxy resin composition of Comparative Example 1 was 93 parts by weight that exceeded 92 parts by weight. The results are shown in Table 3.

### Comparative Example 2

The experiment was carried out in the same manner as in Example 1 except the amount of carbon precursor A was 7.0 parts by weight rather than 1.0 part by weight. The amount of fused spherical silica was adjusted according to the amount of the carbon precursor A. The results are shown in Table 3.

### Comparative Example 3

The experiment was carried out in the same manner as in Example 1 except the amount of carbon precursor A was 0.1 part by weight rather than 1.0 part by weight. The amount of fused spherical silica was adjusted according to the amount of the carbon precursor A. The results are shown in Table 3.

### Comparative Example 4

The experiment was carried out in the same way as in Example 1 except for using carbon precursor E instead of the carbon precursor A. The results are shown in Table 3.

Carbon precursor E: Phenol resin with an average particle diameter of 80 μm was dried and carbonized at 500° C. for 4 hours to obtain carbon precursor E in an yield of 99%. The carbon precursor E obtained had a hydrogen/carbon ratio by weight of 6/92, an average particle diameter of 55 μm, the maximum particle diameter of 70 μm, and a specific electric resistivity of 1×10¹⁰·cm.

### Comparative Example 5

The experiment was carried out in the same way as in Example 1 except for using carbon precursor F instead of the carbon precursor A. The results are shown in Table 3.

Carbon precursor F: Phenol resin with an average particle diameter of 4.5 μm was dried and carbonized at 520° C. for 4 hours to obtain carbon precursor F in an yield of 99%. The carbon precursor F obtained had a hydrogen/carbon ratio by weight of 5/92, an average particle diameter of 3 μm, the maximum particle diameter of 15 μm, and a specific electric resistivity of 1×10⁹·cm.

### Comparative Example 6

The experiment was carried out in the same way as in Example 1 except for using carbon precursor G instead of the carbon precursor A. The results are shown in Table 3.

Carbon precursor G: phenol resin with an average particle diameter of 4.5 μm was dried and carbonized at 550° C. for 4 hours to obtain carbon precursor G in an yield of 99%. The carbon precursor G obtained had a hydrogen/carbon ratio by weight of 5/93, an average particle diameter of 3 μm, the maximum particle diameter of 15 μm, and a specific electric resistivity of 1×10⁸·cm.

### Comparative Example 7

The experiment was carried out in the same manner as in Example 1 except for using 0.5 part by weight of the following carbon black A instead of 1.0 part by weight of the carbon precursor A. The amount of fused spherical silica was adjusted according to the amount of the carbon precursor A. The results are shown in Table 3.

Carbon black A: “MA600” manufactured by Mitsubishi Chemical Corp. (hydrogen/carbon ratio by weight: 1.5/98, size of aggregates: 300 nm, size of agglomerates: 100 μm, specific electric resistivity: 4×10⁻¹·cm)

TABLE 2

| | Example | | | | | | |
|---|---|---|---|---|---|---|---|
| | 1 | 2 | 3 | 4 | 5 | 6 | 7 |
| Biphenyl epoxy resin | 8.5 | 8.5 | 8.5 | 8.5 | 8.5 | 8.5 | 8.5 |
| Phenolnovolac resin | 4.5 | 4.5 | 4.5 | 4.5 | 4.5 | 4.5 | 4.5 |
| Fused spherical silica | 84.4 | 83.6 | 82.4 | 84.9 | 84.4 | 82.4 | 84.4 |
| Carbon precursor A | 1.0 | 1.8 | 3.0 | 0.5 | | | |
| Carbon precursor B | | | | | 1.0 | | |
| Carbon precursor C | | | | | | 3.0 | |
| Carbon precursor D | | | | | | | 1.0 |
| Triphenylphosphine | 0.2 | 0.2 | 0.2 | 0.2 | 0.2 | 0.2 | 0.2 |
| Antimony trioxide | 1.0 | 1.0 | 1.0 | 1.0 | 1.0 | 1.0 | 1.0 |
| Carnauba wax | 0.4 | 0.4 | 0.4 | 0.4 | 0.4 | 0.4 | 0.4 |
| Spiral flow (cm) | 160 | 153 | 140 | 155 | 165 | 170 | 145 |
| | (accepted) | (accepted) | (accepted) | (accepted) | (accepted) | (accepted) | (accepted) |
| YAG laser marking | Accepted | Accepted | Accepted | Accepted | Accepted | Accepted | Accepted |
| properties | | | | | | | |
| External appearance | Accepted | Accepted | Accepted | Accepted | Accepted | Accepted | Accepted |
| (color of cured product) | (black) | (black) | (black) | (black) | (black) | (black) | (black) |
| Solder crack | 0/22 | 0/22 | 0/22 | 0/22 | 0/22 | 0/22 | 0/22 |
| | (accepted) | (accepted) | (accepted) | (accepted) | (accepted) | (accepted) | (accepted) |
| Leak defects | 0/100 | 0/100 | 0/100 | 0/100 | 0/100 | 0/100 | 0/100 |
| | (accepted) | (accepted) | (accepted) | (accepted) | (accepted) | (accepted) | (accepted) |
| Carbon precursor aggregates | 0 | 0 | 0 | 0 | 0 | 0 | 0 |
| (>80 μm) | (accepted) | (accepted) | (accepted) | (accepted) | (accepted) | (accepted) | (accepted) |
| Maximum gold wire | 1.0 | 1.5 | 2.5 | 1.5 | 0.8 | 0.8 | 2.3 |
| dislocation rate (%) | (accepted) | (accepted) | (accepted) | (accepted) | (accepted) | (accepted) | (accepted) |
| Comprehensive judgement | Accepted | Accepted | Accepted | Accepted | Accepted | Accepted | Accepted |

TABLE 3

| | Comparative Example | | | | | | |
|---|---|---|---|---|---|---|---|
| | 1 | 2 | 3 | 4 | 5 | 6 | 7 |
| Biphenyl epoxy resin | 3.3 | 8.5 | 8.5 | 8.5 | 8.5 | 8.5 | 8.5 |
| Phenolnovolac resin | 1.8 | 4.5 | 4.5 | 4.5 | 4.5 | 4.5 | 4.5 |
| Fused spherical silica | 93.0 | 78.4 | 85.3 | 84.4 | 84.4 | 84.4 | 84.9 |
| Carbon precursor A | 1.0 | 7.0 | 0.1 | | | | |
| Carbon precursor E | | | | 1.0 | | | |
| Carbon precursor F | | | | | 1.0 | | |
| Carbon precursor G | | | | | | 1.0 | |
| Carbon black A | | | | | | | 0.5 |
| Triphenylphosphine | 0.1 | 0.2 | 0.2 | 0.2 | 0.2 | 0.2 | 0.2 |
| Antimony trioxide | 0.5 | 1.0 | 1.0 | 1.0 | 1.0 | 1.0 | 1.0 |
| Carnauba wax | 0.3 | 0.4 | 0.4 | 0.4 | 0.4 | 0.4 | 0.4 |
| Spiral flow (cm) | 81 | 98 | 150 | 150 | 162 | 158 | 155 |
| | (rejected) | (rejected) | (accepted) | (accepted) | (accepted) | (accepted) | (accepted) |
| YAG laser marking | Accepted | Accepted | Rejected | Accepted | Accepted | Accepted | Accepted |
| properties | | | | | | | |
| External appearance | Accepted | Accepted | Rejected | Rejected | Accepted | Accepted | Accepted |
| (color of cured product) | (black) | (black) | (gray) | (gray) | (black) | (black) | (black) |
| Solder crack | 0/22 | 3/22 | 0/22 | 0/22 | 0/22 | 0/22 | 0/22 |
| | (accepted) | (rejected) | (accepted) | (accepted) | (accepted) | (accepted) | (accepted) |
| Leak defects | 0/100 | 0/100 | 0/100 | 0/100 | 0/100 | 0/100 | 1/100 |
| | (accepted) | (accepted) | (accepted) | (accepted) | (accepted) | (accepted) | (rejected) |
| Carbon precursor aggregates | 0 | 0 | 0 | 3 | 2 | 1 | 0 |
| (>80 μm) | (accepted) | (accepted) | (accepted) | (rejected) | (rejected) | (rejected) | (accepted) |
| Maximum gold wire | 10 | 8.8 | 1.5 | 4.5 | 3.9 | 4.1 | 1.0 |
| dislocation rate (%) | (rejected) | (rejected) | (accepted) | (rejected) | (rejected) | (rejected) | (accepted) |
| Comprehensive judgement | Rejected | Rejected | Rejected | Rejected | Rejected | Rejected | Rejected |

What is claimed is:

1. An epoxy resin composition for semiconductor sealing comprising an epoxy resin, a phenol resin, an inorganic filler, a curing accelerator, and a carbon precursor having a specific electric resistivity in a semiconductor region of 1×10²·cm or more but less than 1×10⁷·cm as essential components, wherein the amounts of the inorganic filler and the carbon precursor in the epoxy resin composition are respectively 65-92 wt % and 0.1-5.0 wt %.

2. The epoxy resin composition for semiconductor sealing according to claim 1, wherein the carbon precursor has an H/C ratio by weight determined by elemental analysis of 2/97 to 4/93.

3. The epoxy resin composition for semiconductor sealing according to claim 1, wherein the carbon precursor is fine particles having an average particle diameter of 0.5-50 μm.

4. The epoxy resin composition for semiconductor sealing according to claim 1, wherein the carbon precursor is fine particles having an average particle diameter of 0.5-20 μm.

5. The epoxy resin composition for semiconductor sealing according to claim 1, wherein the carbon precursor has a specific electric resistivity of 1×10⁴·cm or more but less than 1×10⁷·cm.

6. The epoxy resin composition for semiconductor sealing according to claim 1, wherein the amount of the inorganic filler in the total amount of the epoxy resin composition is 70-91 wt %.

7. The epoxy resin composition for semiconductor sealing according to claim 1, wherein the carbon precursor is produced by carbonizing a phenol resin at a calcination temperature of 600-650° C.

8. A semiconductor device comprising a semiconductor element sealed using the epoxy resin composition for semiconductor sealing according to any one of claims 1-7.
